(19) United States
(12) Patent Application Publication
(10) Pub. No.: US 2026/0004182 A1
(43) Pub. Date: Jan. 1, 2026

(54) SYSTEM AND METHOD FOR AUTOMATICALLY GENERATING AND UPDATING CLASSIFICATION MODELS

(71) Applicant: Actimize Ltd., Ra'anana (IL)

(72) Inventors: Yonit MARCUS, Rehovot (IL); Kiran Kumar BATHULA, Mandamarri (IN); Ankur PALIWAL, Pune (IN)

(73) Assignee: Actimize Ltd., Ra'anana (IL)

(21) Appl. No.: 18/756,598

(22) Filed: Jun. 27, 2024

(51) Int. Cl. G06N 20/00

(52) U.S. Cl. CPC G06N 20/00

(57) ABSTRACT

A system and method for automatically training a machine learning model may include a computing device; a memory; and a processor, the processor configured to: use of one or more subgroups of decision variables of a first machine learning model to train one or more candidate models; evaluate performance metric of one or more candidate models against the first machine learning model: when the performance metric of one or more candidate models is higher than the performance metric of the first machine learning model, update the first machine learning model to a second machine learning model selected from one or more candidate models.

### TECHNICAL FIELD OF THE INVENTION

The present invention relates generally to the management of machine learning models, specifically to the automatic generation and updating of machine learning models.

### BACKGROUND OF THE INVENTION

Many machine learning (ML) models suffer from a deterioration of performance over time as a result of their static training but their use in handling evolving transactional data. This loss may lead to significant problems for those relying on ML output such as detection systems, e.g. for fraudulent and suspicious activity, where this deterioration can result, e.g. in financial and reputation losses and fines from regulatory bodies for failing to report activity while adversely affecting customers, or victims involved in fraudulent and suspicious activities. Generating and updating machine learning models is generally labor-intensive.

Thus, there is a need for a solution that allows for automatically generating and updating machine learning models.

### SUMMARY OF THE INVENTION

Embodiments of the invention may improve the technology of machine learning model generation, by or example intelligently creating input to an artificial intelligence model, e.g. to generate candidate ML models, to identify improvements of candidate ML models over an existing ML model which are otherwise difficult for computerized processes to identify. Improvements and advantages of embodiments of the invention may include automatically generating or updating ML model-based re-training of previous ML models and comparison of their performance with the original model.

Improvements and advantages of embodiments of the invention may include making real-time decisions concerning the lifecycle of ML models using machine learning.

One embodiment may include a method of automatically training a machine learning model, the method including: using one or more subgroups of decision variables (such as algorithm, hyperparameter, features, or thresholds) of a first machine learning model to train one or more candidate models; evaluating performance metric of the one or more candidate models against the first machine learning model; when the performance metric of the one or more candidate models are higher than the performance metric of the first machine learning model, updating the first machine learning model to a second machine learning model selected from the one or more candidate models.

One embodiment includes, when the performance metric of the first machine learning model are higher than the performance metric of the one or more candidate models, maintaining the first machine learning model.

In one embodiment, the performance metric of the first machine learning model is periodically compared to threshold performance values, and training of the candidate machine learning model is automatically initiated when the performance metric for the first machine learning model falls below the threshold performance values.

In an embodiment, selecting one or more subgroups of the decision variables includes selecting one or more machine learning algorithms to be implemented in the one or more candidate models.

In an embodiment, the one or more subgroups of the decision variables include one or more of: machine learning algorithm, machine learning model features and hyperparameters of the first machine learning model.

In an embodiment, the training includes amending one or more hyperparameters of machine learning algorithms.

In one embodiment, the subgroup of decision variables includes additional or different decision variables to the decision variables present in the first machine learning model.

In one embodiment, the evaluation of the performance metric of the first machine learning model and the one or more candidate models includes comparison of a first receiver operating characteristic graph to a second receiver operating characteristic graph.

In one embodiment, wherein when a transaction risk score is above threshold value, taking action, the action selected from the group consisting of blocking the transaction, delaying the transaction, sending an alert for a transaction of a user.

In one embodiment, when a transaction risk score is below a threshold value, completing a transaction for a user.

In one embodiment, wherein the machine learning model is trained to detect financial crime in transactions.

One embodiment may include a system for training a machine learning model, the system including: a computing device; a memory; and a processor, the processor configured to: use of one or more subgroups of decision variables of a first machine learning model to train one or more candidate models; evaluate performance metric of the one or more candidate models against the first machine learning model: when the performance metric of the one or more candidate models are higher than the performance metric of the first machine learning model, update the first machine learning model to a second machine learning model selected from the one or more candidate models.

One embodiment includes updating a machine learning model, wherein the method includes: using decision variables of a first machine learning model to generate an updated machine learning model; evaluating performance indicators of the updated machine learning model and the first machine learning model: when the performance indicators of the first machine learning model are higher than the performance indicators of the second machine learning model, proceed with the first machine learning model; and when the performance indicators of the second machine learning model are higher than the performance indicators of the first machine learning model, proceed with the updated machine learning model.

These, additional, and/or other aspects and/or advantages of the present invention may be set forth in the detailed description which follows; possibly inferable from the detailed description; and/or learnable by practice of the present invention.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 shows a block diagram of an exemplary computing device which may be used with embodiments of the present invention.

FIG. 2 is a schematic drawing of a system for automatically training a machine learning model, according to some embodiments of the invention.

FIG. 3 depicts a flowchart of methods of managing interaction transcripts based on dynamic rules, according to some embodiments of the present invention.

FIG. 4A illustrates an exemplary system of components for training a machine learning model, according to some embodiments of the invention.

FIG. 4B illustrates an exemplary system of components for training a machine learning model, according to some embodiments of the invention.

FIG. 5 illustrates an exemplary system of components for training a machine learning model, according to some embodiments of the invention.

FIG. 6 depicts a flowchart that illustrates operations in an automated initiation of training a machine learning model, according to some embodiments of the present invention.

FIG. 7 depicts a flowchart that illustrates operations in the generation of candidate ML models and the evaluation of candidate ML models and previous ML models, according to some embodiments of the present invention.

FIG. 8 depicts a flowchart that illustrates the selection of decision variables for subgroups of decision variables and the selection of algorithms in the training of candidate ML models, according to some embodiments of the present invention.

FIG. 9 depicts a flowchart that illustrates the training of candidate models via variation of hyperparameters, according to some embodiments of the present invention.

FIGS. 10A-F depict example performance metric for evaluating a first machine learning model and one or more candidate ML models, according to some embodiments of the present invention:

FIG. 10A is a boxplot diagram that illustrates a monthly distribution of a transaction risk score for a candidate model, according to some embodiments of the present invention.

FIG. 10B is a boxplot diagram that illustrates a monthly distribution of transaction amount (normalized currency) for a candidate model, according to some embodiments of the present invention.

FIG. 10C is a boxplot diagram that illustrates a monthly distribution of a calculated account current balance for a candidate model, according to some embodiments of the present invention.

FIG. 10D is a diagram that illustrates a monthly distribution for categorial variable “activity with old payee” for a candidate model, according to some embodiments of the present invention.

FIG. 10E is a diagram that illustrates a monthly distribution for categorial variable “alert based feedback” for a candidate model, according to some embodiments of the present invention.

FIG. 10F is a diagram that illustrates a monthly distribution for categorial variable “old online device identifier for party” for a candidate model, according to some embodiments of the present invention.

FIG. 11 is an example for a performance metric analysis in form of a comparison of a receiver operating characteristic graph of a first ML model and a second receiver operating characteristic graph of a second ML model, according to some embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF EMBODIMENTS OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Before at least one embodiment of the invention is explained in detail, it is to be understood that the invention is not limited in its application to the details of construction and the arrangement of the components set forth in the following description or illustrated in the drawings. The invention is applicable to other embodiments that may be practiced or carried out in various ways as well as to combinations of the disclosed embodiments. Also, it is to be understood that the phraseology and terminology employed herein is for the purpose of description and should not be regarded as limiting.

Unless specifically stated otherwise, as apparent from the following discussions, it is appreciated that throughout the specification discussions utilizing terms such as “processing”, “computing”, “calculating”, “determining”, “enhancing” or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices. Any of the disclosed modules or units may be at least partially implemented by a computer processor.

As used herein, “machine learning”, “machine learning algorithms”, “machine learning models”, “ML”, or similar, may refer to models built by algorithms in response to/based on input sample or training data. ML models may make predictions or decisions without being explicitly programmed to do so. ML models require training/learning based on the input data, which may take various forms. In a supervised ML approach, input sample data may include data which is labeled, for example, in the present application, the input sample data may include a transcript of an interaction and a label indicating whether or not the interaction was fraudulent or related to suspicious or fraudulent activity. In an unsupervised ML approach, the input sample data may not include any labels, for example, in the present application, the input sample data may include transactional data only.

ML models may, for example, include (artificial) neural networks (NN), decision trees, regression analysis, Bayesian networks, Gaussian networks, genetic processes, etc. Additionally or alternatively, ensemble learning methods may be used which may use multiple/modified learning algorithms, for example, to enhance performance. Ensemble methods, may, for example, include “Random forest” methods or “XGBoost” methods.

Neural networks (NN) (or connectionist systems) are computing systems inspired by biological computing systems, but operating using manufactured digital computing technology. NNs are made up of computing units typically called neurons (which are artificial neurons or nodes, as opposed to biological neurons) communicating with each other via connections, links or edges. In common NN implementations, the signal at the link between artificial neurons or nodes can be for example a real number, and the output of each neuron or node can be computed by function of the (typically weighted) sum of its inputs, such as a rectified linear unit (ReLU) function. NN links or edges typically have a weight that adjusts as learning proceeds. The weight increases or decreases the strength of the signal at a connection. Typically, NN neurons or nodes are divided or arranged into layers, where different layers can perform different kinds of transformations on their inputs and can have different patterns of connections with other layers. NN systems can learn to perform tasks by considering example input data, generally without being programmed with any task-specific rules, being presented with the correct output for the data, and self-correcting, or learning.

Various types of NNs exist. For example, a convolutional neural network (CNN) can be a deep, feed-forward network, which includes one or more convolutional layers, fully connected layers, and/or pooling layers. CNNs are particularly useful for visual applications. Other NNs can include for example transformer NNs, useful for speech or natural language applications, and long short-term memory (LSTM) networks.

In practice, a NN, or NN learning, can be simulated by one or more computing nodes or cores, such as generic central processing units (CPUs, e.g., as embodied in personal computers) or graphics processing units (GPUs such as provided by Nvidia Corporation), which can be connected by a data network. A NN can be modelled as an abstract mathematical object and translated physically to CPU or GPU as for example a sequence of matrix operations where entries in the matrix represent neurons (e.g., artificial neurons connected by edges or links) and matrix functions represent functions of the NN.

Typical NNs can require that nodes of one layer depend on the output of a previous layer as their inputs. Current systems typically proceed in a synchronous manner, first typically executing all (or substantially all) of the outputs of a prior layer to feed the outputs as inputs to the next layer. Each layer can be executed on a set of cores synchronously (or substantially synchronously), which can require a large amount of computational power, on the order of 10s or even 100s of Teraflops, or a large set of cores. On modern GPUs this can be done using 4,000-5,000 cores.

It will be understood that any subsequent reference to “machine learning”, “machine learning algorithms”, “machine learning models”, “ML”, or similar, may refer to any/all of the above ML examples, as well as any other ML models and methods as may be considered appropriate.

A “subgroup of decision variables” may be a set of training conditions for a ML model. For example a subgroup of decision variables may include features, hyperparameters, and/or training algorithms.

A “hyperparameter” may be configuration variable set before training a machine learning model that control the learning process. Hyperparameters may include, for example learning rate, batch size, number of nodes and layers in a neural network, number of trees and maximum depth in tree algorithms, etc.

A “feature” may be a measurable property, for example a column in a structured dataset. Some of the features in transactional data may include amount of the transaction, account balance, account age, etc.

A “training algorithm” or “algorithm” may be a procedure to run on data and recognize patterns or rules for making predictions, for instance, logistic regression, decision trees, random forest, XGBoost, NN, etc.

Data used for training a candidate models may include new transactions data with labels denoting whether or not they are found to be linked to financial crime or not. Data may be accumulated after a first ML model is trained. The data used for training may contain features that represent the properties of transactions such as the transaction amount, account balance etc. This data may be accumulated over time as more transactions take place and this newly available data can be used to train the candidate or second ML models by using or splitting it for training, validation and test datasets. Candidate machine learning models may be trained on data that is available after and or before the first machine learning model is deployed for predictions.

A “machine learning model” may be a machine learning model which has been identified to require an update. For example, machine learning models are periodically updated, e.g. every month or every year, or updating a machine learning model, e.g. by training one or more candidate models, may be initiated when performance metric of a first machine learning model fall below threshold performance values. For example, updating of ML model A may be initiated when the number of correctly identified fraudulent transaction requests lies below, for example, 50% of all fraudulent transaction requests.

A “candidate model” may be a machine learning model which is a potential successor of a machine learning model. A candidate model may be trained by selecting one or more subgroups of decision variables, e.g. modified or previously applied features, hyperparameters, data items in the form of training datasets or validation datasets of a previous ML model or new training datasets/validation datasets and/or training algorithms. The decision variables forming the subgroup may be selected from a larger group of decision variables such as hyperparameters, features, algorithms or training datasets. For example, a subgroup of decision variables may be automatically selected, e.g. from available algorithms, e.g. new algorithms which did not exist when the previous ML model was trained, or training datasets which include training datasets which have been generated after a machine learning model has been initiated, e.g. after completion of the training of a previous machine learning model.

“Performance metric”, also referred to herein as “performance indicator”, may be a data item or analysis result that indicate a status or quality of a ML model, the accuracy of its output, etc. For example, a machine learning model that is trained to detect fraudulent transactions may be evaluated based on comparison of one or more of: number of transactions which have been correctly assigned as fraudulent, number of transactions which have been incorrectly assigned as fraudulent, number of transaction which have been correctly assigned as genuine, non-fraudulent transactions and/or number of transaction which have been incorrectly assigned as genuine, non-fraudulent transactions.

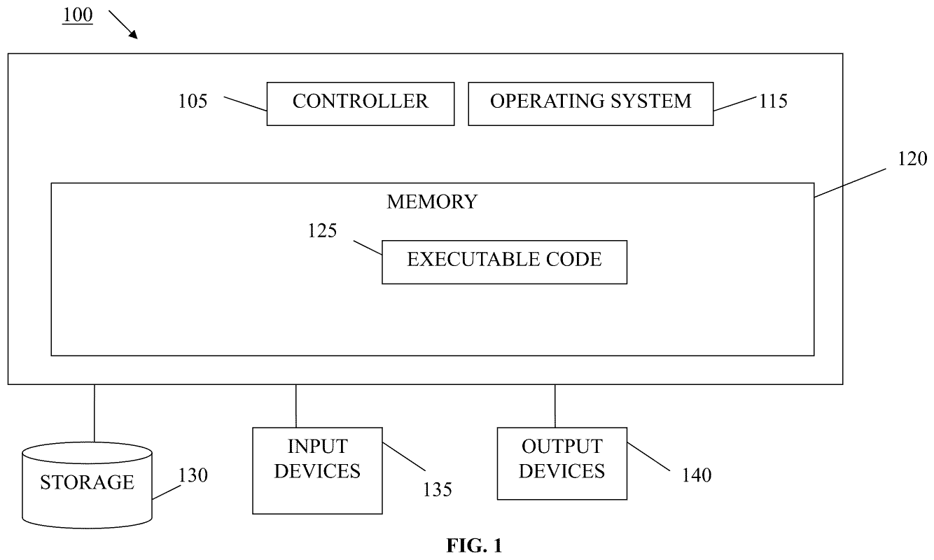

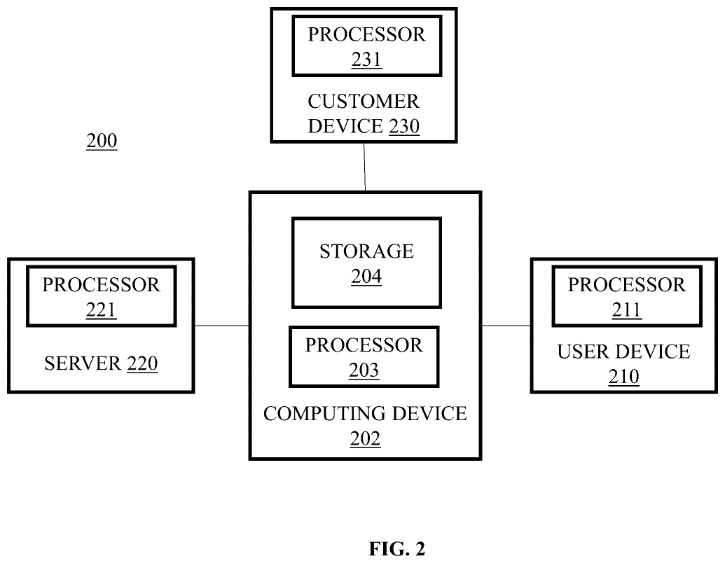

FIG. 1 shows a high-level block diagram of an exemplary computing device which may be used with embodiments of the present invention. Computing device 100 may include a controller or processor 105 that may be, for example, a central processing unit processor (CPU), a chip or any suitable computing or computational device, an operating system 115, a memory 120, a storage 130, input devices 135 and output devices 140 such as a computer display or monitor displaying for example a computer desktop system. Each of modules and equipment and other devices and modules discussed herein, e.g. ML modules, computers training or comparing ML modules, computing device 202, client device 210, server 220, computing device 406, customer network 400 such as on-premise computer networks where the detection systems and the ML models are run, cloud-side network 450 such as Actimize Watch by Nice Ltd. which may be stored on a cloud storage, where data is transmitted from a customer network 400 to train ML models, performance calculator service 562, auto-refresh service 564 and modules in FIGS. 2, 3, 4A, 4B, 5, 7, 8, 9, may be or include, or may be executed by, a computing device such as included in FIG. 1 although various units among these modules may be combined into one computing device.

Operating system 115 may be or may include any code segment designed and/or configured to perform tasks involving coordination, scheduling, arbitration, supervising, controlling or otherwise managing operation of computing device 100, for example, scheduling execution of programs. Memory 120 may be or may include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 120 may be or may include a plurality of, possibly different memory units. Memory 120 may store for example, instructions (e.g. code 125) to carry out a method as disclosed herein, and/or data.

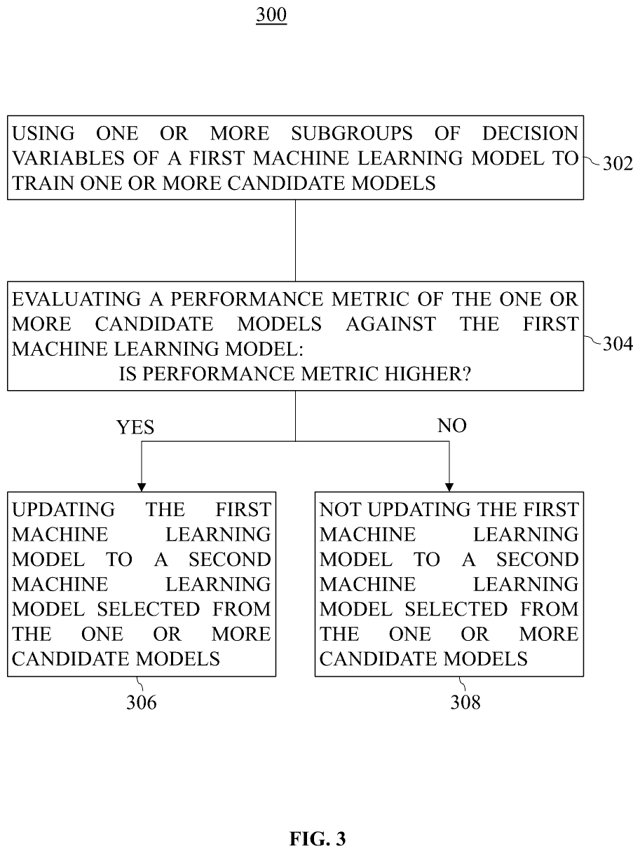

Executable code 125 may be any executable code, e.g., an application, a program, a process, task or script. Executable code 125 may be executed by controller 105 possibly under control of operating system 115. For example, executable code 125 may be one or more applications performing methods as disclosed herein, for example those of FIG. 3 according to embodiments of the present invention. In some embodiments, more than one computing device 100 or components of device 100 may be used for multiple functions described herein. For the various modules and functions described herein, one or more computing devices 100 or components of computing device 100 may be used. Devices that include components similar or different to those included in computing device 100 may be used, and may be connected to a network and used as a system. One or more processor(s) 105 may be configured to carry out embodiments of the present invention by, for example, executing software or code. Storage 130 may be or may include, for example, a hard disk drive, a floppy disk drive, a Compact Disk (CD) drive, a CD-Recordable (CD-R) drive, a universal serial bus (USB) device or other suitable removable and/or fixed storage unit. Data may be stored in a storage 130 and may be loaded from storage 130 into a memory 120 where it may be processed by controller 105. In some embodiments, some of the components shown in FIG. 1 may be omitted.

Input devices 135 may be or may include a mouse, a keyboard, a touch screen or pad or any suitable input device. It will be recognized that any suitable number of input devices may be operatively connected to computing device 100 as shown by block 135. Output devices 140 may include one or more displays, speakers and/or any other suitable output devices. It will be recognized that any suitable number of output devices may be operatively connected to computing device 100 as shown by block 140. Any applicable input/output (I/O) devices may be connected to computing device 100, for example, a wired or wireless network interface card (NIC), a modem, printer or facsimile machine, a universal serial bus (USB) device or external hard drive may be included in input devices 135 and/or output devices 140.

Embodiments of the invention may include one or more article(s) (e.g. memory 120 or storage 130) such as a computer or processor non-transitory readable medium, or a computer or processor non-transitory storage medium, such as for example a memory, a disk drive, or a USB flash memory, encoding, including or storing instructions, e.g., computer-executable instructions, which, when executed by a processor or controller, carry out methods disclosed herein.

FIG. 2 is a schematic drawing of a system 200 according to some embodiments of the invention. System 200 may include a computing device 202 including a processor 203 and storage 204. Computing agent device 202 may be connected to a user device 210 that includes processor 211. Computing device 202 may be connected to a server 220 including processor 221. Server 220 and client device 210 may provide computing device 202 with a machine learning model or decision variables of a machine learning model. Computing agent device 202 may be connected to a customer device 230 that includes processor 231.

Computing devices 100, 202, 210, 220, and 230 may be servers, personal computers, desktop computers, mobile computers, laptop computers, and notebook computers or any other suitable device such as a cellular telephone, personal digital assistant (PDA), video game console, etc., and may include wired or wireless connections or modems. Computing devices 100, 202, 210, 220, and 230 may include one or more input devices, for receiving input from a user (e.g., via a pointing device, click-wheel or mouse, keys, touch screen, recorder/microphone, or other input components). Computers 100, 202, 210, 220, and 230 may include one or more output devices (e.g., a monitor, screen, or speaker) for displaying or conveying data to a user.

Any computing devices of FIGS. 1 and 2 (e.g., 100, 202, 210, 220, 230), or their constituent parts, may be configured to carry out any of the methods of the present invention. Any computing devices of FIGS. 1 and 2, or their constituent parts, may include a performance calculator service 562, auto-refresh service 564, or another engine or module, which may be configured to perform some or all of the methods of the present invention. Systems and methods of the present invention may be incorporated into or form part of a larger platform or a system/ecosystem, such as agent management platforms. The platform, system, or ecosystem may be run using the computing devices of FIGS. 1 and 2, or their constituent parts. A processor such as processor 203 of computing device 202, a processor 211 of device 210, and/or a processor 231 of device 230 may be configured to identify decision variables in a first machine learning model, e.g. features, learning algorithms or hyperparameters “learning rate” or “max_depth”. A learning rate may determine a size of a step taken in each iteration of an optimization algorithm of a ML model, which affects the model's accuracy and convergence. It may control how quickly a ML model can learn from data during the ML model training. “Max_depth” may determine how much a decision tree can be grown during the ML model training. Depth of a tree may be the number of nodes along the longest path from the root node to the farthest leaf node. A processor such as processor 203 of computing device 202, and/or a processor 211 of device 210 may be configured to select one or more subgroups of decision variables for training one or more candidate models. A subgroup may include decision variables such as hyperparameters, features, or a combination thereof. A processor such as processor 203 of computing device 202, and/or a processor 211 of device 210 may be configured to train one or more candidate models from selected one or more subgroups of decision variables using machine learning. A processor such as processor 203 of computing device 202, and/or a processor 211 of device 210 may be configured to evaluate performance metric of one or more candidate models against a first machine learning model. For example, when performance metric of a first machine learning model are higher than performance metric of one or more candidate models, a processor may be configured to maintain a first machine learning model, e.g. to continue to use a first machine model and/or configured to re-train a candidate model, e.g. using one or more subgroups of decision variables of a first machine learning model that is different to one or more subgroups of decision variables of a first machine learning model in a first training process of candidate models. For example, when performance metric of one or more candidate models are higher than performance metric of a first machine learning model, a processor may be configured to update a first machine learning model to a second machine learning model selected from one or more candidate models.

FIG. 3 shows a flowchart of a method 300 of automatically training a machine learning model, e.g. interaction data received as part of interactions between an agent, e.g. agent using user device 210 and customer using customer device 230 which may have been received by computing device 202. The system displayed in FIG. 2 and the method shown in FIG. 3 may refer to the automatically training a machine learning model based on identified decision variables in a first machine learning model which have been received from a customer device, e.g. 210, or a database, e.g. server 220, however, the system and the method may also be used to generate a prediction prompt when executed on a server or agent device. According to some embodiments, some or all of the steps of the method are performed (e.g., fully or partially) by one or more of the computational components, for example, those shown in FIGS. 1 and 2.

In operation 302, one or more subgroups of decision variables of a first machine learning model may be used to train one or more candidate models. For example, decision variables may be parameters, e.g. hyperparameters such as “learning rate” or “max_depth”. A candidate model, also referred to herein as a second ML model, may be an updated ML model of a first machine learning model. An “updated ML model” may be a ML model that is modified by a modification of a training algorithm, data used in the training of the model, e.g. a newer training dataset, or an evaluation of input to a ML model using different thresholds in a decision making process. The identification of decision parameters may proceed, for example, by identifying decision variables from artifacts such as the binary or executable files corresponding to the model, metadata stored related to the model. For example, hyperparameters, list of features and algorithm types may be available within the executable files, the list of raw features which need to be transformed before they can be used in the generation of a candidate model which can be made from parts of metadata files. For example, automatically training a machine learning model by a training service may include the use of subgroups of decision variables. Decision variables may be identified, e.g. from previous or related fraud detection ML models may be used. Alternatively, decision variables may be selected, e.g. from a previous generation of a candidate machine learning model. Training of a machine learning model may also include the engineering of features, where new features are created using various feature engineering techniques known in the art. Features may be selected for a candidate model, e.g. based on calculations of importance or correlation. Examples of feature engineering techniques may include: scaling, one-hot-encoding, or ratios based on transaction activities. For example, training of a candidate model may proceed with, or keep using, the same ML algorithm, which has been used in the generation of a first ML model. Alternatively, training of a candidate model may proceed with, or use, a different ML algorithm, which may not have been used in the generation of a first ML model. ML model algorithms may be selected from XGBoost by The XGBoost Contributors and CatBoost by Yandex, but are not limited to the two aforementioned algorithms and any algorithm known in the art may be used in the training of a ML model.

For example training of a candidate model may include a variation of hyperparameters of a machine learning model, e.g. amendment or alteration of hyperparameters such as learning rate, max_depth, number of trees via random search, grid search, Bayesian optimization.

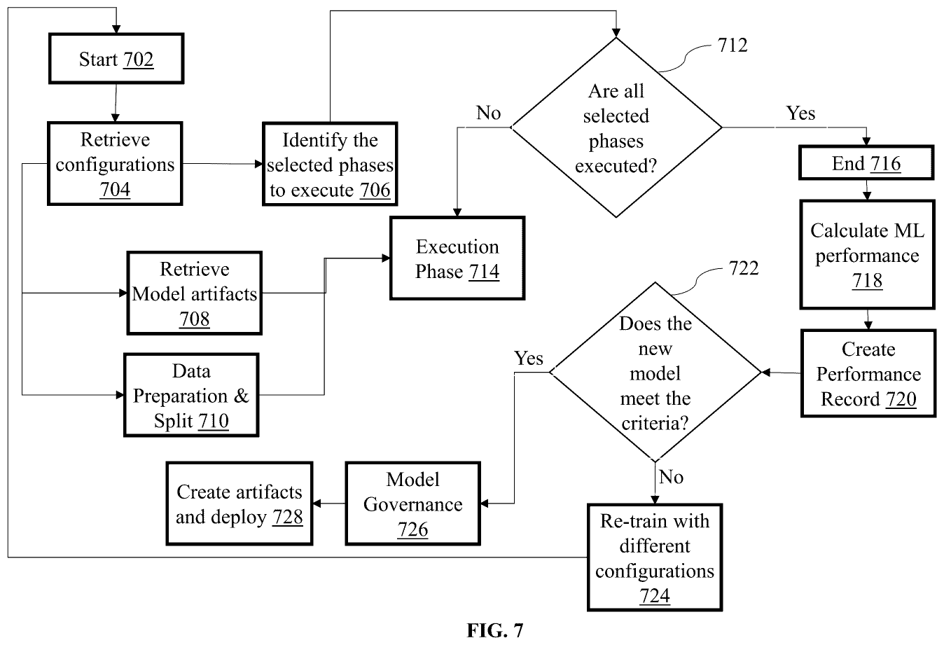

Training of candidate models may be carried out in different training phases and trained candidate models may be evaluated against a first ML model with respect to their performance metric after each phase. A training phase of a ML training may lead to one or more candidate models from a subgroup of decision variables. For example, in one training phase, candidate models may be trained using the same training algorithm, features, and the hyperparameters as a first ML model but training proceeds on a new training dataset, e.g. one or more subgroups of decision variables. In one training phase, the same training algorithm and features used in a first ML model may be used in training candidate models but candidate models are trained using a subgroup of hyperparameters. In one training phase, a candidate model may be trained based on a variation in training algorithm, hyperparameters and a subset of decision variables, but features of a first ML model are used in the training of the candidate model. In one training phase, a candidate model may be trained based on a variation in hyperparameters, a subset of decision variables, and features but a training algorithm of a first ML model may be used in the training of the candidate model. In one training phase, a candidate ML model may be trained based on a variation in hyperparameters, a subset of decision variables, features and training algorithm compared to a first ML model. In some instances, one or more of the above mentioned training phases may be used in the training of a machine learning model. Training phases of a training of one or more candidate models may be identified, e.g. in identification step 706 shown in FIG. 7. In some instances, one or more training phases may be applied in a set order or in any order. Candidate models may be evaluated in their performance after each training phase or may be evaluated after several, e.g. two, three or four training phases have been completed. In embodiments, a training or re-training of a machine learning model is only initiated when a trained candidate model has performance metric which are equal to or lower than a first machine learning model. Training of one or more candidate models using one or more of the training phases may lead to the training of one or more candidate ML models. A subgroup of decision variables used in the training of one or more candidate models may include additional or a different set of decision variables to the decision variables present in the first machine learning model such as additional features or a different set hyperparameters due to the choice of algorithm.

A candidate model may be trained on data items and/or decision variables which have been received after release of a first machine learning model.

In operation 304, a performance metric of one or more candidate models may be evaluated against or in comparison to a first machine learning model. A candidate model may be a new ML model which is trained based on a subgroup of decision variables of a first machine learning model. For example, data items may include analytic variables, e.g. variables which have been mapped or have been received, e.g. from an external database, that were not available when a first model was trained, or other features that describe generated data items such as specific login locations or receiver banks that may have been allocated a higher risk score after training of a first ML model. In another example, evaluation of performance metric of one or more candidate models and a first ML model may include comparison of values of performance metrics such as detection rates (DR), value detection rates (VDR), false positive rate (FPR) of one or more candidate models in a first ML model; comparison of Area under Curve (AUC) values of one or more candidate models and a first ML model. DR may be the ratio between the number of fraudulent or suspicious activities identified by a model at a given alert rate and the total number of all fraudulent/suspicious activities present in a test dataset. VDR may be the ratio between the sum of the currency amounts of fraudulent/suspicious activities identified by a ML model at a given alert rate and the sum of the currency amounts of all fraudulent/suspicious activities present in a test dataset. False Positive Rate (FPR) may be the ratio between false positive determination of fraud or suspicious activity and the combination of false positive+true negative determination of fraud or suspicious activity.

For example, comparison of detection rates may include comparison of ratios of correctly identified fraudulent interactions to the number of all assessed transactions for a first machine learning model and one or more candidate models. For example, a first ML model may correctly identify 20 fraudulent transactions out of 100 assessed transactions and a candidate model may correctly identify 15 fraudulent transactions out of 100 assessed transactions, the first ML model has a higher detection rate of fraudulent transactions and the first ML model may not be updated to the candidate model. For example, a first ML model may correctly identify 6 fraudulent transactions out of 100 assessed transactions and a candidate model may correctly identify 15 fraudulent transactions out of 100 assessed transactions, the first ML model has a lower detection rate of fraudulent transactions and the first ML model may be updated to the candidate model.

Evaluation of performance metric of one or more candidate models against a first machine learning model may include evaluation of one or more performance metrics (operation 304). For example, evaluation may include one performance metric for the candidate model and one performance metric for the first ML model, e.g. detection rate of fraudulent transactions, and evaluation of one performance metric may lead to updating or not updating a first machine learning model to a candidate model. For example, evaluation may include more than one performance metric for the candidate model and more than one performance metric for the first ML model, e.g. DR of fraudulent transactions, VDR of fraudulent transactions and FPR, and evaluation of three performance metrics may lead to updating or not updating a first machine learning model to a candidate model. For example, a ML model may be updated when a majority of evaluated performance metrics for a candidate model is higher than evaluated performance metrics for a first machine learning model (operation 306) and a ML model may not be updated when a majority of evaluated performance metrics for a candidate model is equal to or lower than evaluated performance metrics for a first machine learning model (operation 308). Other ways of comparing the performance of different ML models may be used.

For example, when a performance metric of one or more candidate models are higher than a performance metric of a first machine learning model (operation 306), a first machine learning model may be updated to a second machine learning model selected from one or more candidate models. Updating a first ML model to a second machine learning model may include for example selecting a second machine learning model from one or more candidate models and replacing the first ML model with the second machine learning model. A selection of a candidate model as a second ML model from one or more candidate models may include the selection of a candidate model with the highest performance metric of one or more candidate models. The highest performance metric may be identified, e.g. by comparing detection rates (DR) or value detection rates (VDR) for each of the one or more candidate models which show higher performance metric than a first ML model. A selection of a candidate model as a second machine learning model from one or more candidate models may proceed by comparing a performance metric chosen from the multiple available performance metrics of the one or more candidate models.

For example, when a performance metric of one or more candidate models is not higher than a performance metric of a first machine learning model (operation 308), a first machine learning model may not be updated to a second machine learning model selected from one or more candidate models. For example, in case that evaluation of a performance metric showed equal to or lower performance metric for a candidate model than for a first ML model, a candidate model may be re-trained, e.g. under different subgroup of decision variables, e.g. a different training algorithm.

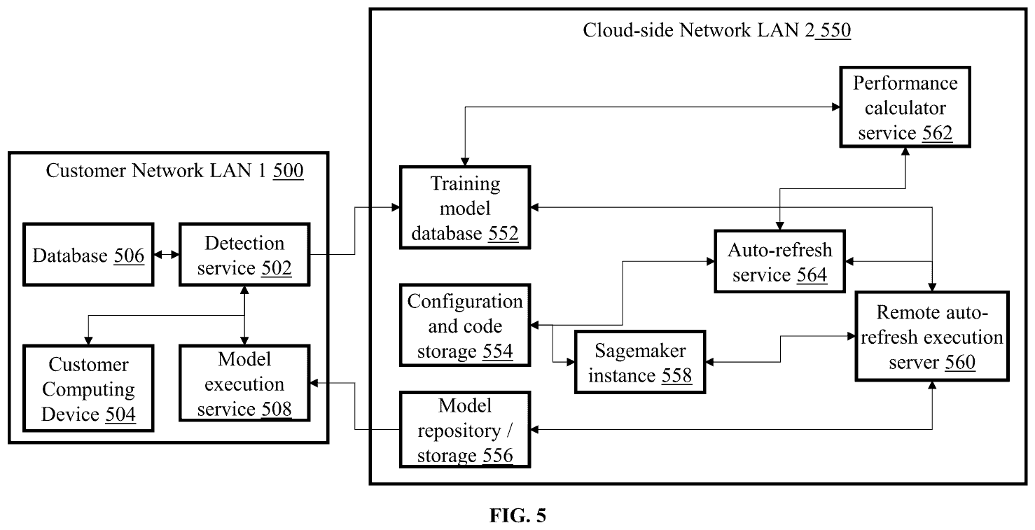

A ML model may be trained to detect financial crime in transactions. For example, a ML model may be trained to assign a transaction risk score to a transaction and may create an alert in cases that a transaction risk score for a transaction is higher than a set threshold value. For example, for each transaction request, a fraud detection system may send a request to a ML model executing service and a model execution service, e.g. model execution service 508 shown in FIG. 5, may execute (e.g. using inference) a model on a transaction and return a transaction risk score which may be generated by a ML model. Detection of financial crime, e.g. via detection service 502 shown in FIG. 5, in transactions may be part of a performance metric in an evaluation of one or more candidate ML models and a first ML model. For example, one or more candidate models and a first ML model may be compared based on the number of created alerts for transaction risks in relation to all transactions as a performance metric. For example, a machine learning model M may correctly identify 3 alerts in 100 transactions and a candidate model C may correctly identify 10 alerts in 100 transactions. In this case, the performance metric suggests that candidate model C has higher performance metric than ML model M and ML model M may be updated to candidate model C. For example, a machine learning model M may correctly identify 15 alerts in 100 transactions and a candidate model C may correctly identify 6 alerts in 100 transactions. In this case, the performance metric suggests that candidate model C has equal to or lower performance metric than ML model M and ML model M may not be updated to candidate model C.

A fraud investigation service 502 may receive an alert for a transaction and may evaluate a transaction. For example, a fraud investigation service may take action and may carry out one or more of the following actions:
A transaction may be blocked, e.g. when a transaction risk score exceeds a threshold value, e.g. based on an indication that a transaction is fraudulent. For example, a customer account linked to a fraudulent transaction may be blocked. Blocking, allowing, delaying, etc. of a transaction, or challenging a customer, may be performed automatically and electronically, e.g. using systems as described herein.
A customer may be challenged, e.g. when a transaction risk score is below a threshold value that clearly indicates fraud but above a second threshold value that indicates a potential risk of a fraudulent transaction, a customer may be challenged, e.g. to provide any form of customer identification or transaction confirmation.
A transaction may be allowed, e.g. when a transaction risk score lies below a risk score. In this case, a transaction may be completed.
A transaction may be delayed, e.g. by a day, a week, a month or until a customer can provide documents proving their identity.

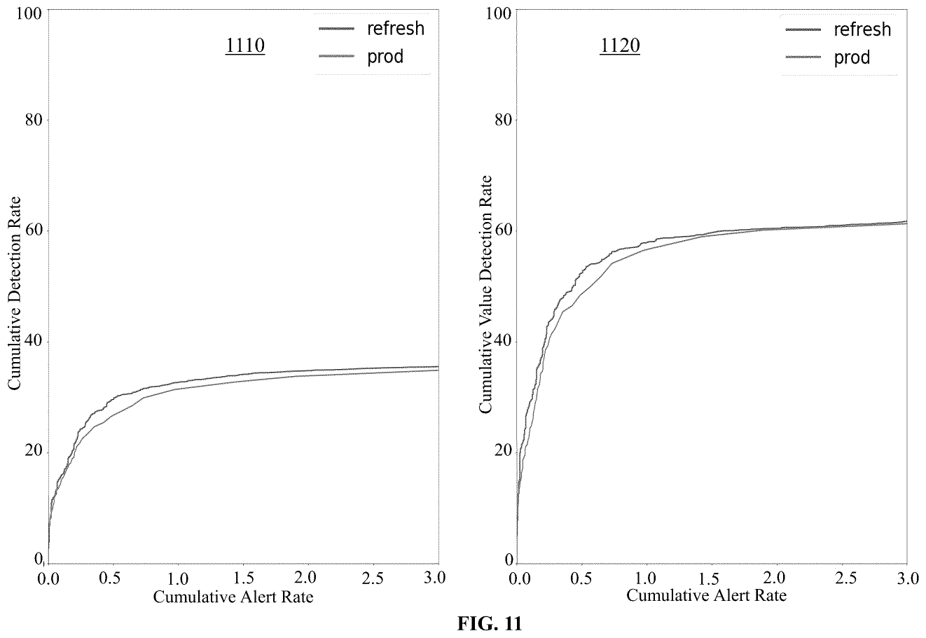

In the comparison of a performance metric of one or more candidate models to a first ML model, a comparison of a performance metric may include generating transaction risk scores and detecting and classifying transactions into fraudulent transactions and non-fraudulent transactions. Comparison of a performance metric of one or more candidate models and a first machine learning model may allow evaluating whether or not a candidate model provides a better, e.g. a more accurate classification of transactions into fraudulent transactions and genuine transactions. Such an evaluation of a performance metric may be conducted, e.g. by comparison of a first receiver operating characteristic graph (ROC graph) of a first ML model to a second receiver operating characteristic graph of a candidate model as shown in FIG. 11. Area under the ROC curve (AUC) may be a performance metric for evaluating one or more candidate models against a first ML model. Area under the ROC curve (AUC) may be measured to generate a numerical value of the area for each ML model. A higher numerical value for an AUC for a ML model may indicate a higher performance metric of the model.

Automatically training a machine learning model may allow using one or more subgroups of decision variables of a first ML model to train candidate models in the detection of fraudulent transactions and to select candidate models which show a higher accuracy in the classification of fraudulent and genuine transactions.

Training of machine learning models may be initiated automatically, e.g. training may be initiated after one or more of the performance metrics of a first machine learning model fall below or lie above their corresponding pre-set threshold values, e.g. performance metrics that may be assessed are: average daily VDR in the last 30 days, average daily DR in the last 30 days, VDR in the last 30 days, DR in the last 30 days, FPR in the last 30 days.

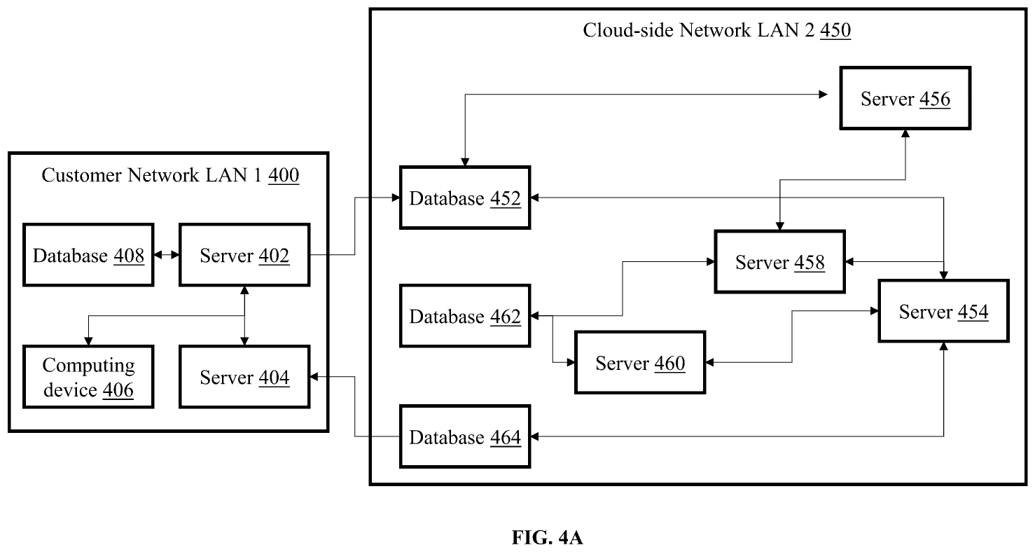

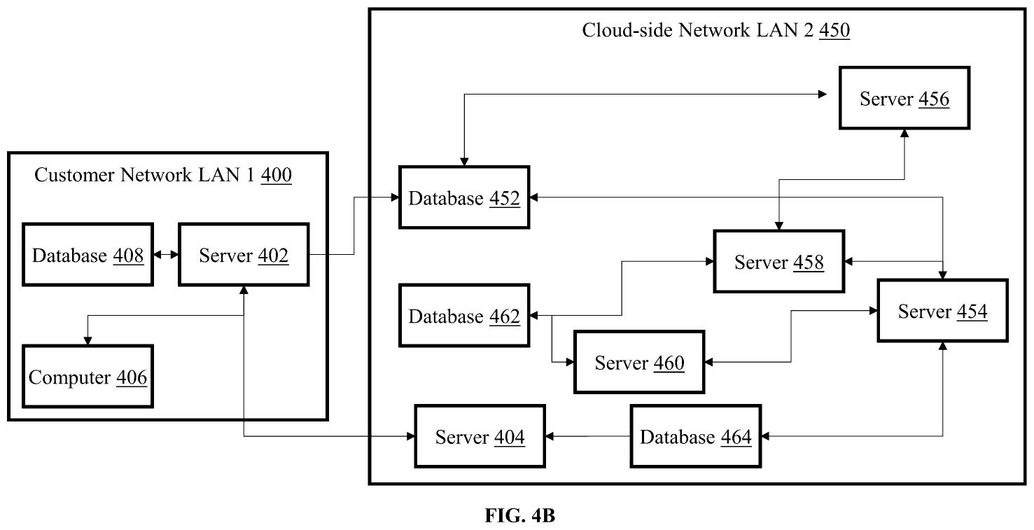

FIG. 4A illustrates an exemplary system of components for training a machine learning model. Computing devices 100, 202, 210 220 or 230 of FIGS. 1 and 2 or their constituent parts, may be configured to carry out any of the methods of the present invention. Any computing devices of FIGS. 1 and 2 or their constituent parts, may include servers 454, 456 or 458, or databases 452, 462 or 464.

A customer-side network 400 (LAN1) may be connected to a cloud-side network 450 (LAN 2). Server 402 may be a server which is located in customer network 400 (LAN1). Server 402 may be connected to server 404, computer 406 and database 408 which are located within customer-side network 400.

Server 402 may be connected to database 452 of cloud-side network 450 (LAN 2), e.g. via a network, e.g. internet or a private network connection. Data may be transferred between server 402 and database 452. Data may be transferred between server 402 and database 408. Data may be transferred between server 402 and computer 406. Data may be transferred between server 402 and server 404.

Computer 406 may be a computing device, e.g. computing device 100 or 230 which is located in customer-side network 400 (LAN1). Computer 406 may be connected to server 402. Computing device 406 may be connected to server 404.

Database 408 may be a database, e.g. database of customer device 230, which is located in customer-side network 400 (LAN1). Database 408 may be connected to server 402. Data may be send or retrieved to database 408 by server 402.

Server 404 may be a server, e.g. server of computing device 230, which is located in customer-side network 400 (LAN1). Data may be transferred between server 404 and server 402. Server 404 may be connected to database 464 of cloud-side network 450 (LAN 2), e.g. via a network, e.g. internet or a private network connection. Data provided from database 464 may be retrieved and read by server 404.

Database 452 may be a database, e.g. a database of computing device 100 or 202, which is located in cloud-side network 450 (LAN2). Database 452 may be connected to server 402 via a network, e.g. internet or a private network connection. Database 452 may be connected to server 454 and server 456 via cloud-side network 450. Data may be read or may be written by server 454 and server 456 on database 452.

Database 462 may be connected to server 460 and server 458 of cloud-side network 450. Data may be written on database 462 or may be read from database 462 by server 458 and/or 460.

Database 464 may be a database, e.g. a database of computing device 100 or 202, which is located in cloud-side network 450. Database 462 may be connected to server 454 located in cloud-side network 450. Data may be read or may be written on database 464 by server 454. Database 464 may be connected to server 404 via a network, e.g. internet or a private network connection. Data stored in database 464 may be read by server 404.

Server 460 may be a server, e.g. a server of computing device 100 or 202 or server 220, which is located in cloud-side network 450. Server 450 may be connected to database 462 and server 454 of cloud-side network 450. Server 460 may send or retrieve data from database 462. Data may be transferred between server 460 and server 454.

Server 454 may be a server, e.g. a server of computing device 100 or 202 or server 220, which is located in cloud-side network 450. Server 454 may be connected to server 460 and 458 located within cloud-side network 450. Data may be transferred between server 454 and server 460. Data may be transferred between server 454 and server 458. Server 454 may be connected to database 452 and/or database 464 located within cloud-side network 450.

Server 456 may be a server, e.g. a server of computing device 100 or 202 or server 220, which is located in cloud-side network 450. Server 456 may be connected to server 458 of cloud-side network 450. Data may be transferred between server 456 and server 458. Server 456 may be connected to database 452 of cloud-side network 450. Server 456 may retrieve or store data of database 452.

Server 458 may be a server, e.g. a server of computing device 100 or 202 or server 220, which is located in cloud-side network 450. Server 458 may be connected to server 454 and/or server 456 of cloud-side network 456. Data may be transferred between server 458 and server 454. Data may be transferred between server 458 and server 456. Server 458 may be connected to database 462 located within cloud-side network 450. Server 458 may retrieve or send data to database 462.

FIG. 4B illustrates an exemplary system of components for training a machine learning model. Computing devices 100, 202, 210, 220 or 230 of FIGS. 1 and 2 or their constituent parts, may be configured to carry out any of the methods of the present invention. Any computing devices of FIGS. 1 and 2 or their constituent parts, may include servers 454, 456 or 458, or databases 452, 462 or 464.

In some embodiments, customer-side network 400 (e.g. customer side network 400) may include database 408, server 402 and computer 406 and server 404 may be located within cloud-side network 450.

Server 404 may be a server, e.g. a server of computing device 100 or 202 or server 220, which is located in cloud-side network 450. Server 404 may be connected to database 464 present in cloud-side network 450. Server 404 may be connected to server 402 via a network, e.g. internet or a private network connection.

FIG. 5 illustrates an exemplary system of components for training a machine learning model, according to an embodiment of the invention. Computing devices 100, 202, 210 or 220 of FIGS. 1 and 2 or their constituent parts, may be configured to carry out embodiments of the present invention. For example, any computing devices of FIGS. 1 and 2 or their constituent parts, may include an auto-refresh service 564, a performance calculator service 562, and a training model database 552.

Detection service 502 may be a service which can retrieve input from customers, e.g. details or data related to a planned transaction. Service 502 may process transactions and events, e.g. in real-time or in a batch mode. Service 502 may include rule-based and ML-based detection models such as XGBoost, CatBoost, logistic regression models to identify fraud and money laundering activities. Service 502 may be executed using for example a Linux or windows virtual machine with java virtual machines (JVM) and Python code and scaled to multiple instances to accommodate the volume of data to be processed. Service 502 may be executed within a customer network, e.g. customer network 500.

Customer computing device 504 may be a computing device, e.g. computing device 100 or 230, which may allow a customer initiating a data transfer process from a detection service to a model training database 552. Device 504 may be an entity in customer network 500 or in a cloud-side network 550. While embodiments are described in the context of customers and fraud detection, other ML applications may be used.

Database 506 may a database service which stores transaction data such as transactions, customer details and the results of detection and investigation. Database 506 may be, for example, a database such as Microsoft Structured Query Language Server (MSSQL) by Microsoft Corporation or Oracle database by the Oracle corporation.

Model execution service 508 may be an application which executes a ML model and retrieves input from detection service 502 and provides a risk_score and a label positive/negative as output to detection service 504. Output of a ML model provided to detection service 502 may be in the form of a risk score. Model execution service may be installed in form of containers or virtual machines (VMs) with JVM and Python code.

For example, an example input from a detection service 502 to a model execution service 508 may read:

```
[
{
‘actimizeOperationsTimeSincePartyOpenAlerts': 28,
  ‘AlertBasedFeedback_doNotFilter’: 1,
  ‘actimizeIsHighFocusPayor’: 0,
  ‘actimizeIsCounterpartyOldPayeeForAnyME’: 0,
  ‘actimizeIsRequestedAmountAsEnteredRounded’: 0,
  ‘actimizeDaysSinceAccountHadDebitAndCreditOnSameDay’: 3,
  ‘requestedAmountNormalizedCurrency’: 416.03,
  ‘actimizeCustomerSegmentCd’: 2,
  ‘accountAvailableBalance’: 276337.02,
  ‘aisVar_TotalCountOfTrxInTheLast365Days': 5855,
  ‘aisVar_5DaysAverageAmount’: 921.4242182, ‘ki_AMP_CheckPostingKiting2_SUSPICIO
US_MONTHLY_TRANSACTION_VELOCITY_TO_THE_SAME_PAYEE_CheckPosting
Kiting_2[O_CP_D]_V1’: 1855, ‘ki_AMP_CheckPostingKiting2_UNUSUAL_MONEY_OUT
_TRANSACTION_AMOUNT_TO_AVERAGE_MONEY_IN_AMOUNT_CheckPostingKit
ing_2[O_CP_D]_V2’: 0, ‘ki_AMP_CheckPostingKiting2_NUMBER_OF_MONEY_OUT_T
RANSACTIONS_TO_MONEY_IN_TRANSACTIONS_RATIO_CheckPostingKiting_2[O_{—}
CP_D]_V1’: 39},
  {
‘actimizeOperationsTimeSincePartyOpenAlerts': 31,
  ‘AlertBasedFeedback_doNotFilter’: 0,
  ‘actimizeIsHighFocusPayor’: 0,
  ‘actimizeIsCounterpartyOldPayeeForAnyME’: 0,
  ‘actimizeIsRequestedAmountAsEnteredRounded’: 1,
  ‘actimizeDaysSinceAccountHadDebitAndCreditOnSameDay’: 1,
  ‘requestedAmountNormalizedCurrency’: 1200.0,
  ‘actimizeCustomerSegmentCd’: 1,
  ‘accountAvailableBalance’: 1519.18,
  ‘aisVar_TotalCountOfTrxInTheLast365Days': 79,
  ‘aisVar_5DaysAverageAmount’: 320.695,
‘ki_AMP_CheckPostingKiting2_SUSPICIOUS_MONTHLY_TRANSACTION_VELOCITY
_TO_THE_SAME_PAYEE_CheckPostingKiting_2[O_CP_D]_V1’: 25, ‘ki_AMP_CheckPos
tingKiting2_UNUSUAL_MONEY_OUT_TRANSACTION_AMOUNT_TO_AVERAGE_M
ONEY_IN_AMOUNT_CheckPostingKiting_2[O_CP_D]_V2’: 0, ‘ki_AMP_CheckPostingKit
ing2_NUMBER_OF_MONEY_OUT_TRANSACTIONS_TO_MONEY_IN_TRANSACTIO
NS_RATIO_CheckPostingKiting_2[O_CP_D]_V1’: 0}]
```

For example, an example output from a model execution service 508 may read:

[{“ML_risk_score”: 0.75, “predicted_class”: “fraud”},
{“ML_risk_score”: 0.12, “predicted_class”: “clean”} ]

A cloud-side network 550 may include a model training database 552. Model training database 552 may be a database or a service which stores data required for the training of ML models. For example, database 552 may store transactional data, e.g. a transaction amount, account balance, geolocation of the device used for transaction, etc. Database 552 may also include indicators based on historical behavior of an account holder such as average amount of transaction, or transaction activity. Data for the training of ML models may include relevant and selected fields from transactions, customer data and results of detection and investigation. For example, database 552 may be a storage unit, e.g. a S3 bucket by Amazon Inc., and each dataset may be identified by a unique, user-assigned key.

Configuration and code storage 554 may be storage for configurations, code and notebooks. For example, storage 554 may include generic and customized templates of notebooks, code and configuration which may be required to run auto-refresh service 564. For example, storage 554 may be an S3 or a gitlab-like code repository service. Notebooks may be interactive programming and development tool used by machine learning practitioners to train ML models. They can include code and comments for training ML models.

Model repository storage 556 may be a service and/or a storage/repository for model artifacts. Storage 556 may store model artifacts. For example, storage 556 can store models in various forms such as pickle, Json file or can store blueprint of container images to run the model execution service.

Sagemaker Instance 558 may be a model development environment service. Service 558 may allow customers accessing data and code and to compute securely. Service 558 may provide a programming environment such as Python environment and Jupyter notebooks and Python libraries. Users, e.g. a user using user device 210, can also run or trigger auto-refresh using service 558. Service 558 can be executed, e.g. using entities using Linux operating systems with Python, JVM, Jupyter notebooks installed on a cloud computing device, e.g. computing device 100 or 202.

Remote auto-refresh execution server 560 may be a service which can initiate training of a candidate model, e.g. server 560 can execute an auto-refresh request. Server 560 may execute an auto-refresh request automatically, e.g. after a pre-defined time period or in response to a user request and may generate relevant model artifacts and reports. Generated artifacts may be executable code or binary representation of the feature engineering steps and the trained candidate model that can be deployed to a customer network, e.g. customer network 400, to get inference on new data. Generated artifacts may include files in Json format that include metadata related to a ML model. Reports may be reports of performance metrics, e.g. performance comparison and statistics on data for one or more candidate models and a previously used ML model and a list of hyperparameters and metadata of the trained candidate ML models.

Performance calculator service 562 may be a service that is used to calculate a first ML model's performance metric. For example, service 562 may be used to calculate a model's performance metric based on data stored in a model training database 552 and can execute an auto-refresh service 564. Typically, service 562 can be an AWS Lambda service by Amazon Inc. which is periodically executed, e.g. every week every day etc.

An auto-refresh service 564 may be a service which automatically initiates an auto-refresh execution, e.g. periodically or on request by an agent. Initiating an auto-refresh execution service may be based on configurations available in configuration and code storage 554. Service 564 may be initiated by a performance calculator service 562. A performance calculator service 562 may be an AWS Lambda by Amazon Inc. An auto-refresh service may periodically compare a performance metric of a first machine learning model to threshold values, and training of a candidate machine learning model may be initiated when performance values for a first machine learning model fall below a threshold value. In a case that performance values for a first machine learning model do not fall below a threshold value, no training of a candidate model may be initiated. For example, comparison of a performance metric may include comparing a parameter indicating the percentage of incorrectly predicted fraudulent transaction requests of a machine learning model half a year after release of the first machine learning model to a threshold value of incorrectly predicted fraudulent transaction requests, e.g. obtained immediately after release of a first machine learning model. In case that the percentage of incorrectly predicted fraudulent transactions by a first ML has increased by more than 10% after six months from its release, training of one or more candidate models may be initiated.

Once a candidate model is created, e.g. using auto-refresh service 564, a detection service may review its performance metric: A candidate model may be implemented, e.g. after model governance and testing in various testing environments. A candidate model may be updated, e.g. in cases when a performance metric of a candidate model is equal to or lower than the performance of a currently used first ML model. Auto-refresh service 564 may be re-run with updated configurations, e.g. using a different subgroup of decision variables. In some cases, a candidate model can be created manually, e.g. using a different methodology that is new or customized based on available tools and methods in cases that any of the models trained using prior methods is not good enough.

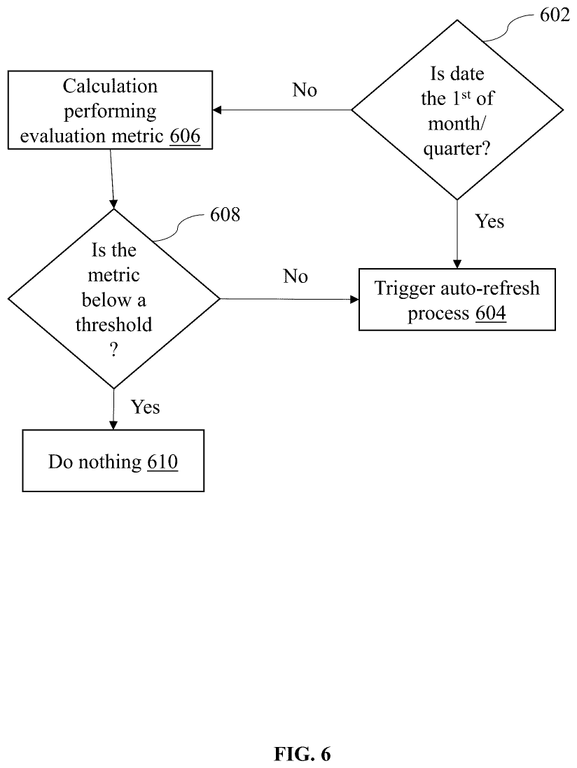

FIG. 6 depicts a flowchart that illustrates operations in an automated initiation of a training a machine learning model, according to an embodiment of the invention. A training application, e.g. for automatically initiating training of a machine learning model may periodically assess whether or not a performance of a machine learning model should be assessed, e.g. by calculating a performance metric of a first ML model, e.g. using performance calculator service 562 shown in FIG. 5. For example, a training application may initiate training or updating of a machine learning model at the beginning of a month and application may check whether or not a date is the first day of the month or of a quarter of a year (operation 602). In case that a machine learning model should be trained or re-trained, a training process 604 may be initiated, e.g. by auto-refresh service 564. For the case that a training application assesses that no training of a machine learning model is needed, a training application may initiate a calculation of a performance metric for a machine learning model (operation 606). In operation 608, it may be assessed whether or not a performance metric is below a threshold value. In case that a performance metric of a machine learning model is below a threshold value, training of the machine learning model may be initiated (operation 604), in case that the performance metric is above a threshold, no action may be taken and a training application may wait a certain time period, e.g. a day, a week, a month, a quarter of a year before assessing the status of a machine learning model (operation 610).

FIG. 7 depicts a flowchart that illustrates operations in the generation of candidate ML models and the evaluation of candidate ML models and previous ML models, according to an embodiment of the invention. Upon initiation of a training of machine learning model (operation 702), configuration for a ML model, e.g. a performance metric of a first ML model may be retrieved, e.g. by performance calculator service 562, (operation 704) and steps in the training of one or more candidate models may be identified, e.g. by identifying training phases 706. For example, training of a ML model may include modifying decision variables of a first ML model such as hyperparameters. For example, one or more subgroups of decision variables may be selected for a training or updating process. In case that decision variables such as hyperparameters may be changed or amended, model artifacts may be retrieved from a first ML model (operation 708) and data available for training may be prepared and split, e.g. to generate a subgroup of data to train one or more candidate models (operation 710). For example, model artifacts may be a binary representation of a ML model such as a pickle file and Json files that include the decision variable values and metadata corresponding to the ML model.

A training application, e.g. remote auto-refresh execution server 560 shown in FIG. 5, may assess whether or not all selected phases in the training of a ML model are executed (operation 712). In case that not all training phases have been completed, training of candidate models is resumed (operation 714). In case that all phases are executed, training of a ML model may end (operation 716) and a model performance of one or more candidate models and a first ML may be calculated (operation 718) and a performance record for one or more candidate models and a first ML model is generated. A performance metric of one or more candidate models may be evaluated against a performance metric of a first ML model (operation 720). Evaluation includes assessing whether or not a performance metric of one or more candidate models meet, exceeds, or is equal to or lower than a performance metric of a first ML model (operation 722). In case that a performance metric of a first machine learning model are higher than a performance metric of one or more candidate models, a first machine learning model may be maintained and/or new candidate models may be re-trained with different configurations (operation 724), e.g. a different subgroup of decision variables. In case that when a performance metric of one or more candidate models is higher than a performance metric of a first machine learning model, a first machine learning model may be updated to a second machine learning model selected from one or more candidate models. For the selected second ML model, model governance 726 may be implemented and in the release of the second ML model, artifacts may be created and the ML model may be deployed (728).

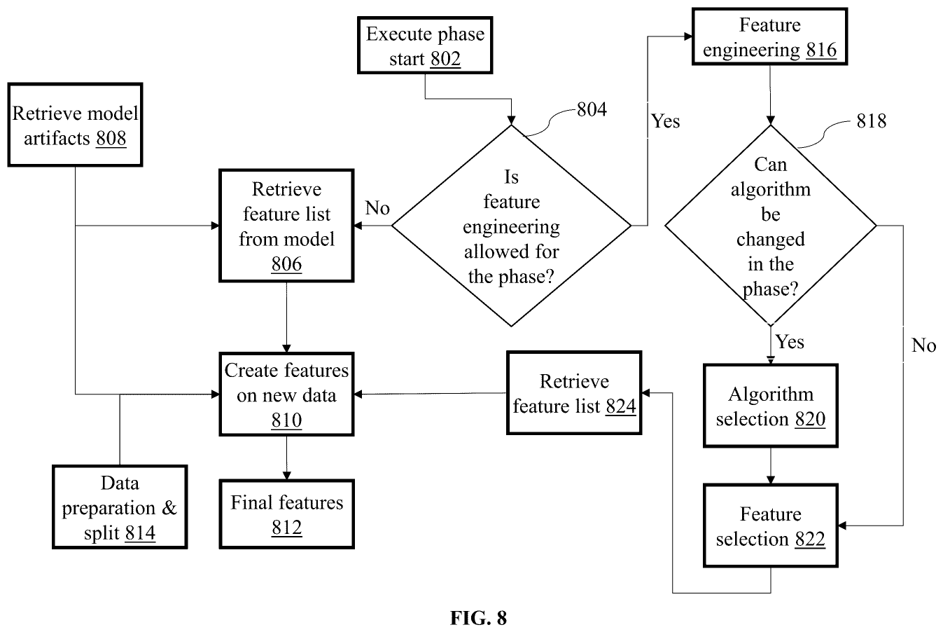

FIG. 8 depicts a flowchart that illustrates the selection of decision variables such as the features, hyperparameters, the selection of algorithms in the training of candidate ML models, according to an embodiment of the invention. In operation 802, when training of one or more candidate models is initiated, a training application may assess whether or not feature engineering is allowed (operation 804). In case that feature engineering is not allowed (operation 806), a feature list, may be retrieved, e.g. from first model. For example data items may be retrieved in form of model artifacts of a first ML model (operation 808). Model artifacts may include data items which may be included in decision variables of a first model such as the algorithm name, hyperparameter, features list, and thresholds, e.g. thresholds for the assessment of a performance metric. Subgroups of these decision variables may be selected for training one or more candidate models. For example, the feature list may be used to create features on new data (operation 810). A subgroup of features, e.g. final features 812, may be selected for training one or more candidate models using machine learning. Training datasets available for training of a machine learning model may be processed by a data preparation and split operation 814. These steps may include fraud augmentation where some clean transactions/activity may be marked as fraudulent or suspicious based on their relationship to existing fraudulent/suspicious activity, filtering data based on date of transactions then splitting data into training datasets and validation, test datasets, e.g. based on the same of date of transaction and removing any fields that cannot be available at the time of prediction on customer network. In case that feature engineering is allowed as part of the decision-variables of the automatic training of the machine learning model, feature engineering techniques such as one-hot encoding, missing value imputation, scaling, ratios between amount, balance columns may be applied to the training data of a candidate model (operation 816), a training application may assess whether or not a training algorithm can be changed in the training phase (818). In case that training algorithms can be changed, a training algorithm may be changed from X to Y (operation 820). For example, a new training algorithm may be selected for the training of a candidate model. Training algorithms may include XGBoost, CatBoost, Logistic Regression, Random Forest. In case that no training algorithms can be changed, feature selection 822 may be executed.

In operation 822, features may be selected for the retrieval of a feature list 824. For example, data that is prepared and split 814 may be used to create new features on new data (operation 810). A subgroup of features, e.g. final features 812, may be selected for training one or more candidate models using machine learning.

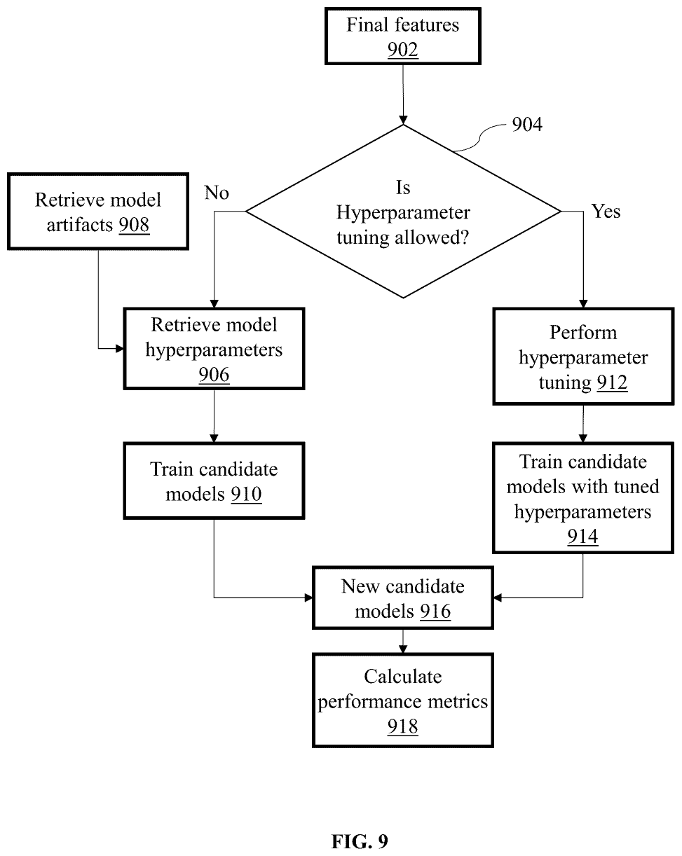

FIG. 9 depicts a flowchart that illustrates the training of candidate models via variation of hyperparameters, according to an embodiment of the invention. Selected data containing the final features 902 may be used in the training of one or more candidate models using machine learning, e.g. by amending hyperparameter for given machine learning model. In operation 904, it is assessed whether or not hyperparameter tuning can be performed in the training of one or more candidate models. In case that no hyperparameter tuning is allowed, previously used hyperparameters 906 may be retrieved, e.g. from a previously used machine learning model. For example, previously used hyperparameters may be retrieved from model artifacts of a previous model 908. A model artifact may be a file which holds metadata for a ML model, e.g. a candidate model, including values used for hyperparameters within a model. Retrieved hyperparameters may be used in the training of one or more candidate models 910. In case that hyperparameter tuning is allowed, hyperparameters may be tuned (operation 912) and candidate models may be trained with tuned hyperparameters (operation 914). Tuning of hyperparameters may be include optimizing hyperparameter values, e.g. to select a most recent set of hyperparameters such as hyperparameter values obtained a week or a month prior to training of candidate models, to obtain best performance of a candidate model. Operations 910 and 914 may result in the provision of one or more candidate models 916. For each trained candidate model, a performance metric is generated (operation 918). In example, a performance metric for a candidate ML model may include generation of a receiver operating characteristic (ROC) graph. Generated performance metrics for one or more candidate ML models may be used in evaluating their performance against the performance of a first machine learning model.

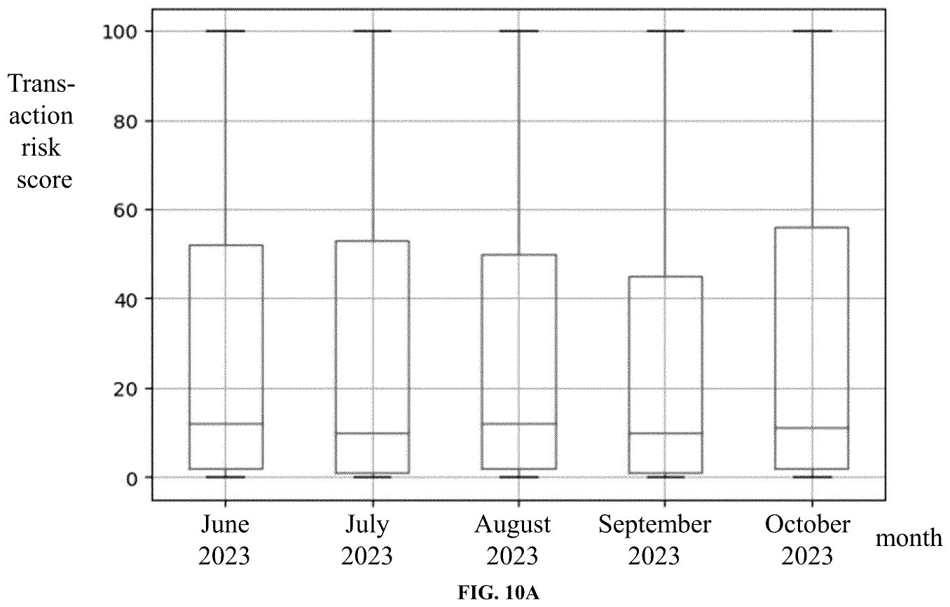

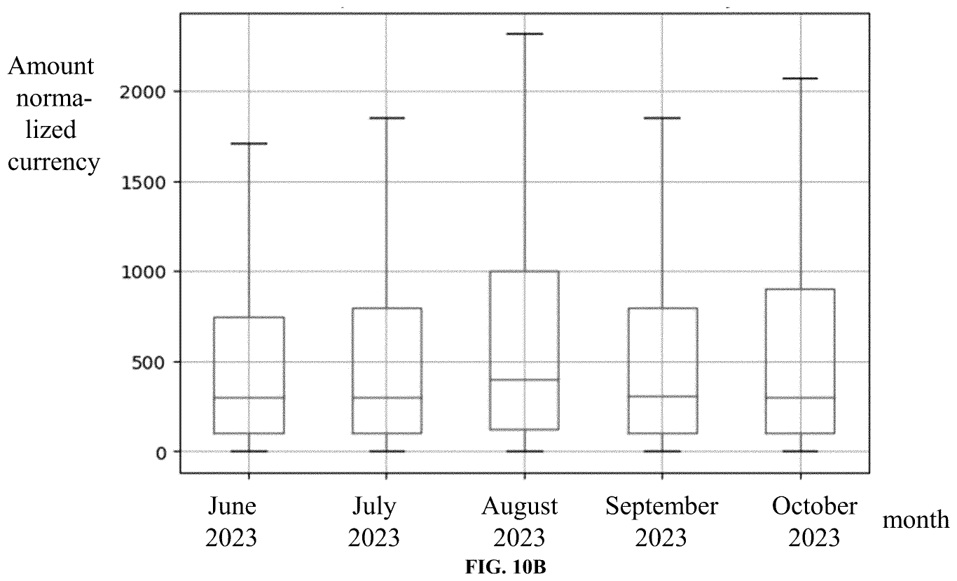

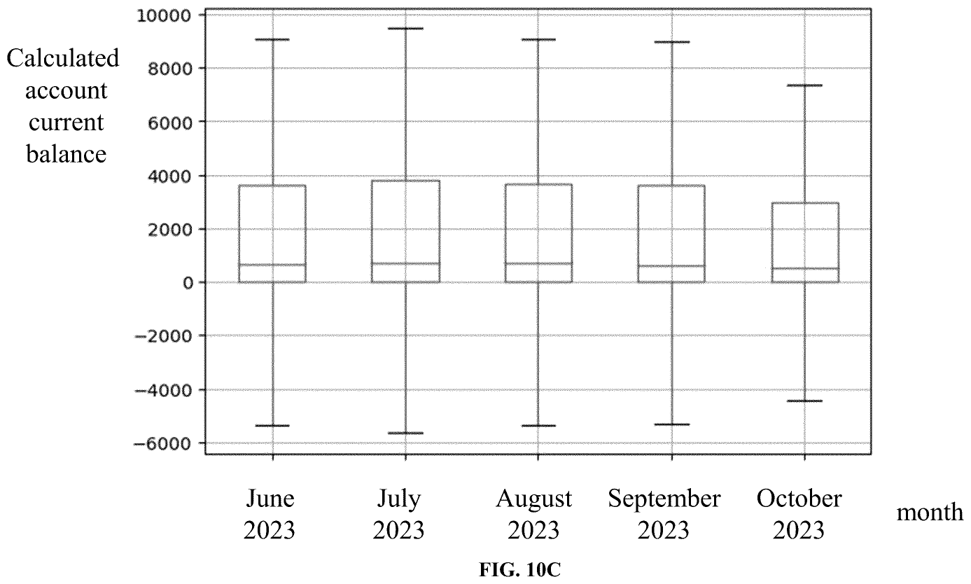

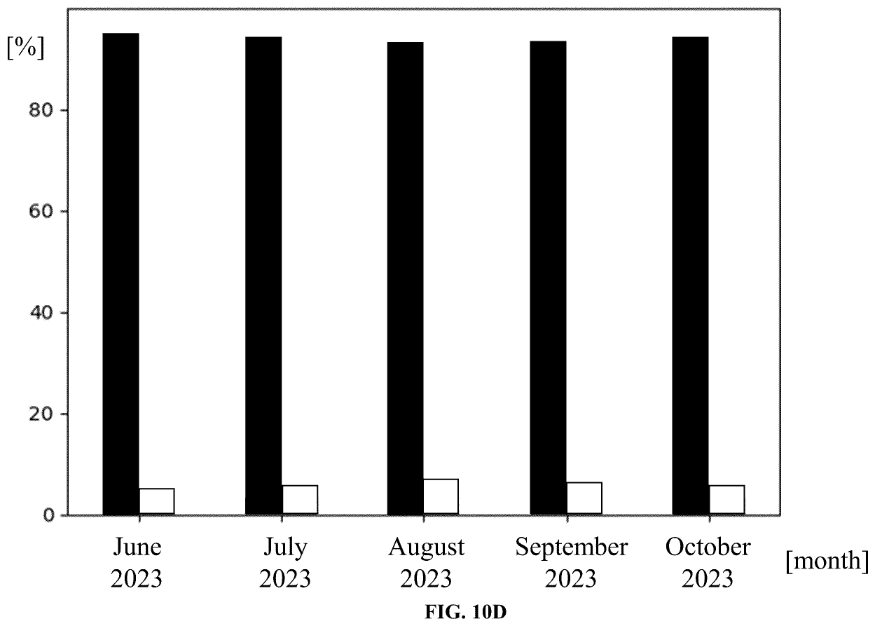

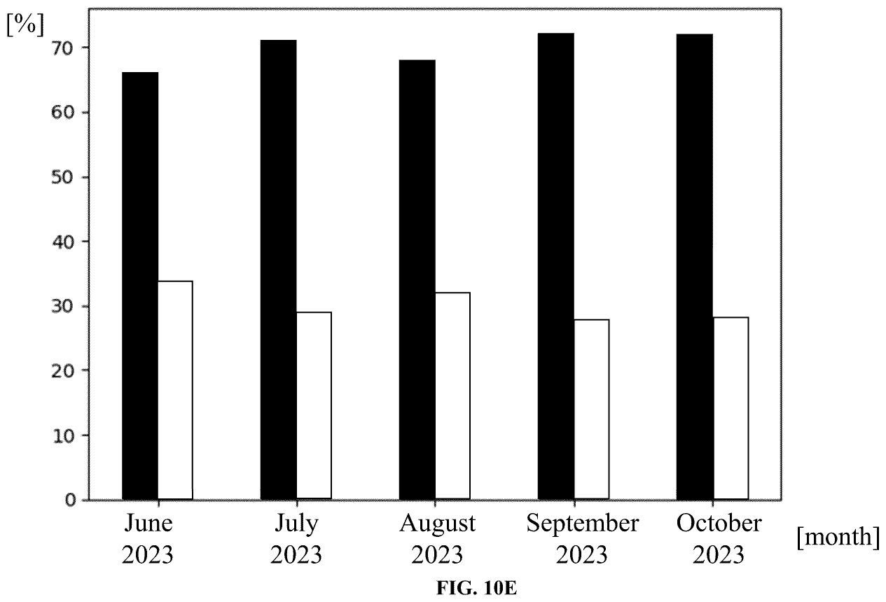

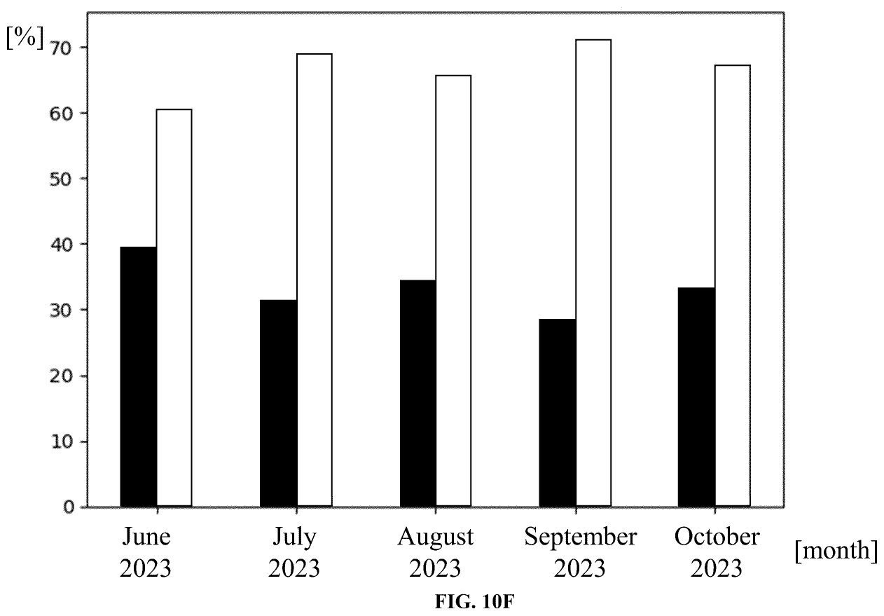

FIG. 10A-F depicts example performance metrics, e.g. data analysis reports, for evaluating a first machine learning model and one or more candidate ML models, according to some embodiments of the present invention. For example, Exploratory Data Analysis (EDA) report may allow reviewing the stability of data produced by ML models and candidate models over time and can also be used to gain business insights:

FIGS. 10A-10C represent the monthly distribution of a numerical feature which may be introduced into a candidate ML model, according to an embodiment of the invention: FIG. 10A is a boxplot diagram that illustrates a monthly distribution of a transaction risk score for a candidate model. FIG. 10B is a boxplot diagram that illustrates a monthly distribution of an amount normalized currency for a candidate model. FIG. 10C is a boxplot diagram that illustrates a monthly distribution of a calculated account current balance for a candidate model.

FIGS. 10D-10F represent the monthly share of three different categories for three different decision variables, according to an embodiment of the invention. The EDA report may allow reviewing produced data of ML models and candidate models, e.g. certain columns shown to a user, e.g. shown as black columns, may represent data items forming part or being associated to legitimate, non-fraudulent transactions and certain columns shown to a user, e.g. shown as white columns, may represent data items forming part or being associated to fraudulent transactions: FIG. 10D is a diagram that illustrates a monthly distribution for categorial variable “activity with old payee” for a candidate model. For example, as shown in FIG. 10D, a vast majority of legitimate, non-fraudulent transactions, over 90% in each month, (certain columns shown to a user, e.g. shown as black columns) may be sent to an old payee, whereas only a small fraction of fraudulent transactions may be sent to an old payee (certain columns shown to a user, e.g. shown as white columns). As shown over a period of five months (June 2023 to October 2023), this trend is stable over time. FIG. 10E is a diagram that illustrates a monthly distribution for categorial variable “alert based feedback” for a candidate model. FIG. 10F is a diagram that illustrates a monthly distribution for categorial variable “old online device identifier for party” for a candidate model.

Numerical features and categories shown in FIGS. 10A-10F may be examples of an EDA report and feature stability reports.

Table 1 shows example evaluation metrics for a candidate model and a first machine learning model. Table 1 includes performance metrics for the performance of a ML model that may be trained with training datasets (indicated by a partition labelled “train”) and validation datasets (indicated by a partition labelled “validation”) and the performance of a ML model which may be trained with training datasets and validation datasets (indicated by a partition labelled “overall”). Additional performance metrics used in the evaluation of candidate models and a first ML model may include area under precision recall curve, area under the ROC curve, and the area under precision recall curve for a specified amount.

TABLE 1

| | Candidate | First ML | |
|---|---|---|---|
| Performance Metrics | Model | Model | Partition |
| Precision_Recall | 0.194 | 0.078 | overall |
| ROC_AUC | 0.854 | 0.852 | overall |
| Precision_Recall_amount | 0.891 | 0.876 | overall |
| ROC_AUC_Amount | 0.944 | 0.942 | overall |
| Precision_Recall | 0.037 | 0.046 | validation |
| ROC_AUC | 0.659 | 0.659 | validation |
| Precision_Recall_amount | 0.61 | 0.609 | validation |
| ROC_AUC_Amount | 0.799 | 0.798 | validation |
| Precision_Recall | 0.181 | 0.056 | training |
| ROC_AUC | 0.829 | 0.826 | training |
| Precision_Recall_Amount | 0.873 | 0.856 | training |
| ROC_AUC_Amount | 0.933 | 0.931 | training |

An example of a model performance report for a candidate model and a first machine learning model at different alert rates for fraud is shown in Table 2.

TABLE 2

| Training Model | Candidate Model | First ML Model |
|---|---|---|
| DR@0.1 | 15.9623 | 15.1264 |
| VDR@0.1 | 29.0353 | 24.4217 |
| DR@0.25 | 24.2595 | 22.1932 |
| VDR@0.25 | 43.6366 | 40.6377 |
| DR@0.5 | 29.6212 | 26.5737 |
| VDR@0.5 | 52.4013 | 48.3686 |
| DR@1 | 32.6881 | 31.4052 |
| VDR@1 | 57.9319 | 56.4980 |
| DR@1.5 | 34.1411 | 32.7284 |
| VDR@1.5 | 59.7050 | 58.9609 |
| DR@2 | 34.8019 | 33.7609 |
| VDR@2 | 60.4536 | 60.1393 |
| DR@2.5 | 35.2423 | 33.7609 |
| VDR@2.5 | 61.0276 | 60.1393 |

Table 2 discloses detection rates (DR), which indicate the number of frauds detected by a ML model out of all frauds which have been identified and value detection rates (VDR), which indicate the percentage amount of the detected frauds over amount of all frauds which may be identified. DR and VDR values are shown for different alert rates. Alert rates may be set by a percentage of transactions alerted based on the score of the refresh model with the model currently in production. For example, an alert rate may be 0.1, 0.25, 0.5, 1, 1.5, 2 or 2.5 percent of all interactions. A DR and VDR may be calculated for different thresholds for creating an alert. For example, a DR@0.1 may represent a DR when the threshold for alerting is selected such that 0.1% of all transactions/activities have predicted risk scores above its value. This may be done to understand the performance of models at various volumes of alerts that need to be manually investigated further to check if the transactions/activities are indeed fraudulent or suspicious.

FIG. 11 is an example for a performance metric analysis in form of a comparison of a receiver operating characteristic graph of a first ML model and a second receiver operating characteristic graph of a second ML model, according to an embodiment of the invention.

Graphs 1110 and 1120 show the detection rates (DR) and value detection rates (VDR) up to a preconfigured alert rates of 3.0 for a candidate model (candidate model labelled refresh) and a first ML model (current model in production labelled prod). Detection rate (DR) may be the ratio between the number of fraudulent/suspicious activity identified by the model at a given alert rate and the total number of all fraudulent/suspicious activity present in a test dataset. A value detection rate (VDR) may be the ratio between the sum of the currency amounts (e.g. dollar, euro, or pound sterling) of a fraudulent/suspicious activities identified by a model at a given alert rate and the sum of the currency amounts (e.g. dollar, euro, or pound sterling) of all fraudulent/suspicious activity present in a test dataset. The candidate model shows an increased cumulative detection rate for cumulative alert rates between 0 to 3 and an increased cumulative value detection rate for cumulative alert rates between 0 to 1.

Services used in the provision training models to a ML model and comparison of performance metric may be SageMaker by Amazon Inc. However, it may be possible to use any other training service or evaluation service known in the art. AWS Lambda and a Sagemaker user interface by Amazon Inc. can define and automatically training of a machine learning model.

### EXAMPLES

An excerpt of an example data structure to be used in the training and/or retraining of a candidate model is shown below. The data structure illustrates two transaction examples including features, e.g. “accountAvailableBalance”, and their respective values for each feature, e.g. “276337.02” for the feature “accountAvailableBalance”, represented as key value pairs:

```
[
{
‘actimizeOperationsTimeSincePartyOpenAlerts': 28,
  ‘AlertBasedFeedback_doNotFilter’: 1,
  ‘actimizeIsHighFocusPayor’: 0,
  ‘actimizeIsCounterpartyOldPayeeForAnyME’: 0,
  ‘actimizeIsRequestedAmountAsEnteredRounded’: 0,
  ‘actimizeDaysSinceAccountHadDebitAndCreditOnSameDay’: 3,
  ‘requestedAmountNormalizedCurrency’: 416.03,
  ‘actimizeCustomerSegmentCd’: 2,
  ‘accountAvailableBalance’: 276337.02,
  ‘aisVar_TotalCountOfTrxInTheLast365Days': 5855,
  ‘aisVar_5DaysAverageAmount’: 921.4242182, ‘ki_AMP_CheckPostingKiting2_SUSPICIO
US_MONTHLY_TRANSACTION_VELOCITY_TO_THE_SAME_PAYEE_CheckPosting
Kiting_2[O_CP_D]_V1’: 1855, ‘ki_AMP_CheckPostingKiting2_UNUSUAL_MONEY_OUT
_TRANSACTION_AMOUNT_TO_AVERAGE_MONEY_IN_AMOUNT_CheckPostingKit
ing_2[O_CP_D]_V2’: 0, ‘ki_AMP_CheckPostingKiting2_NUMBER_OF_MONEY_OUT_T
RANSACTIONS_TO_MONEY_IN_TRANSACTIONS_RATIO_CheckPostingKiting_2[O_{—}
CP_D]_V1’: 39},
  {
‘actimizeOperationsTimeSincePartyOpenAlerts': 31,
  ‘AlertBasedFeedback_doNotFilter’: 0,
  ‘actimizeIsHighFocusPayor’: 0,
  ‘actimizeIsCounterpartyOldPayeeForAnyME’: 0,
  ‘actimizeIsRequestedAmountAsEnteredRounded’: 1,
  ‘actimizeDaysSinceAccountHadDebitAndCreditOnSameDay’: 1,
  ‘requestedAmountNormalizedCurrency’: 1200.0,
  ‘actimizeCustomerSegmentCd’: 1,
  ‘accountAvailableBalance’: 1519.18,
  ‘aisVar_TotalCountOfTrxInTheLast365Days': 79,
  ‘aisVar_5DaysAverageAmount’: 320.695,
‘ki_AMP_CheckPostingKiting2_SUSPICIOUS_MONTHLY_TRANSACTION_VELOCITY
_TO_THE_SAME_PAYEE_CheckPostingKiting_2[O_CP_D]_V1’: 25, ‘ki_AMP_CheckPos
tingKiting2_UNUSUAL_MONEY_OUT_TRANSACTION_AMOUNT_TO_AVERAGE_M
ONEY_IN_AMOUNT_CheckPostingKiting_2[O_CP_D]_V2’: 0, ‘ki_AMP_CheckPostingKit
ing2_NUMBER_OF_MONEY_OUT_TRANSACTIONS_TO_MONEY_IN_TRANSACTIO
NS_RATIO_CheckPostingKiting_2[O_CP_D]_V1’: 0}]
```

The aforementioned flowcharts and diagrams illustrate the architecture, functionality, and operation of possible implementations of systems, methods and computer program products according to various embodiments of the present invention. In this regard, each portion in the flowchart or portion diagrams may represent a module, segment, or portion of code, which comprises one or more executable instructions for implementing the specified logical function(s). It should also be noted that, in some alternative implementations, the functions noted in the portion may occur out of the order noted in the figures. For example, two portions shown in succession may, in fact, be executed substantially concurrently, or the portions may sometimes be executed in the reverse order, depending upon the functionality involved, It will also be noted that each portion of the portion diagrams and/or flowchart illustration, and combinations of portions in the portion diagrams and/or flowchart illustration, can be implemented by special purpose hardware-based systems that perform the specified functions or acts, or combinations of special purpose hardware and computer instructions.

As will be appreciated by one skilled in the art, aspects of the present invention may be embodied as a system or an apparatus. Accordingly, aspects of the present invention may take the form of an entirely hardware embodiment or an embodiment combining software and hardware aspects that may all generally be referred to herein as a “circuit,” “module” or “system.”

The aforementioned figures illustrate the architecture, functionality, and operation of possible implementations of systems and apparatus according to various embodiments of the present invention. Where referred to in the above description, an embodiment is an example or implementation of the invention. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions. It will further be recognized that the aspects of the invention described hereinabove may be combined or otherwise coexist in embodiments of the invention.

It is to be understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The descriptions, examples and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention may be implemented in the testing or practice with materials equivalent or similar to those described herein.

While the invention has been described with respect to a limited number of embodiments, these should not be construed as limitations on the scope of the invention, but rather as exemplifications of some of the preferred embodiments. Other or equivalent variations, modifications, and applications are also within the scope of the invention. Accordingly, the scope of the invention should not be limited by what has thus far been described, but by the appended claims and their legal equivalents.

What is claimed is:

1. A method of automatically training a machine learning model, the method comprising:
using one or more subgroups of decision variables of a first machine learning model to train one or more candidate models;
evaluating a performance metric of said one or more candidate models against said first machine learning model:
when said performance metric of said one or more candidate models are higher than said performance metric of said first machine learning model, updating said first machine learning model to a second machine learning model selected from said one or more candidate models.

2. A method according to claim 1, comprising when said performance metric of said first machine learning model are higher than said performance metric of said one or more candidate models, maintaining said first machine learning model.

3. A method according to claim 1, wherein said performance metric of said first machine learning model are periodically compared to threshold performance values, and training of said candidate machine learning model is automatically initiated when said performance values for said first machine learning model fall below said threshold performance values.

4. A method according to claim 1, wherein selecting one or more subgroups of said decision variables comprises selecting one or more machine learning algorithms to be implemented in said one or more candidate models.

5. A method according to claim 1, wherein said one or more subgroups of said decision variables comprise one or more of: machine learning algorithm, machine learning model features and hyperparameters of said first machine learning model.

6. A method according to claim 1, wherein said training comprises amending one or more hyperparameters of a machine learning algorithms.

7. A method according to claim 1, wherein said subgroup of decision variables comprises additional decision variables to the decision variables present in said first machine learning model.

8. A method according to claim 1, wherein said evaluation of said performance metric of said first machine learning model and said one or more candidate models comprises comparison of a first receiver operating characteristic graph to a second receiver operating characteristic graph.

9. A method according to claim 1, wherein when a transaction risk score is above threshold value, taking action, the action selected from the group consisting of blocking the transaction, delaying the transaction, sending an alert for a transaction of a user.

10. A method according to claim 1, wherein when a interaction risk score is below a threshold value, completing a transaction for a user.

11. A method according to claim 1, wherein said machine learning model is trained to detect financial crime in transactions.

12. A system for training a machine learning model, the system comprising:
a computing device;
a memory; and
a processor, the processor configured to:
use of one or more subgroups of decision variables of a first machine learning model to train one or more candidate models;
evaluate performance metric of said one or more candidate models against said first machine learning model:
when said performance metric of said one or more candidate models are higher than said performance metric of said first machine learning model, update said first machine learning model to a second machine learning model selected from said one or more candidate models.

13. A system according to claim 12, wherein when said performance metric of said first machine learning model are higher than said performance metric of said one or more candidate models, the processor is configured to maintain said first machine learning model.

14. A system according to claim 12, wherein said performance metric of said first machine learning model are periodically compared to threshold performance values, and training of said candidate machine learning model is automatically initiated when said performance values for said first machine learning model fall below said threshold performance values.

15. A system according to claim 12, wherein the selecting one or more subgroups of said decision variables comprises selecting one or more machine learning algorithms to be implemented in said one or more candidate models.

16. A system according to claim 12, wherein said one or more subgroups of said decision variables comprise one or more of: machine learning algorithm, machine learning model features and hyperparameters of said first machine learning model.

17. A system according to claim 12, wherein said training comprises amending one or more hyperparameters of a machine learning algorithms.

18. A system according to claim 12, wherein said candidate or second machine learning models are trained on data that is available after and or before the first machine learning model is deployed for predictions.

19. A system according to claim 12, wherein said evaluation of said performance metric of said first machine learning model and said one or more candidate models comprises a comparison of a first receiver operating characteristic graph to a second receiver operating characteristic graph.

20. A method of updating a machine learning model, the method comprising:
using parameters of decision variables of a first machine learning model to generate an updated machine learning model;
evaluating performance indicators of said updated machine learning model and said first machine learning model:
when said performance indicators of said first machine learning model are higher than said performance indicators of said second machine learning model, proceeding with said first machine learning model; and
when said performance indicators of said second machine learning model are higher than said performance indicators of said first machine learning model, proceeding with said updated machine learning model.
